(19) United States
(12) Patent Application Publication
(10) Pub. No.: US 2013/0100885 A1
(43) Pub. Date: Apr. 25, 2013

(54) SELECTIVELY INVOKING RECEIVE DIVERSITY DURING POWER-UP/INITIAL ACQUISITION AND OUT OF SERVICE MODES

(71) Applicants: Francis Ming-Meng Ngai, Louisville, CO (US); Rashad Ahmed Akbar Attar, San Diego, CA (US); Won Joon Choi, San Diego, CA (US); Stanley Tsai, Frederick, CO (US); Insung Kang, San Diego, CA (US); Jing Sun, San Diego, CA (US); Amir Dabbagh, San Diego, CA (US)

(72) Inventors: Francis Ming-Meng Ngai, Louisville, CO (US); Rashad Ahmed Akbar Attar, San Diego, CA (US); Won Joon Choi, San Diego, CA (US); Stanley Tsai, Frederick, CO (US); Insung Kang, San Diego, CA (US); Jing Sun, San Diego, CA (US); Amir Dabbagh, San Diego, CA (US)

(73) Assignee: Qualcomm Incorporated, San Diego, CA (US)

(21) Appl. No.: 13/633,540

(22) Filed: Oct. 2, 2012

Related U.S. Application Data
(60) Provisional application No. 61/550,589, filed on Oct. 24, 2011.
(60) Provisional application No. 61/556,809, filed on Nov. 7, 2011.

(51) Int. Cl. H04W 4/00

(52) U.S. Cl. 370/328

(57) ABSTRACT

Methods and apparatus for selectively invoking receive diversity during power-up/initial acquisition and out of service modes are disclosed. A method can include selectively enabling receive diversity based on an initial acquisition attempt by one of the receive chains in a wireless device having multiple receive chains. A method can also include enabling receive diversity based on a predetermined list of channels to be acquired. A predetermined list of channels is a subset of a plurality of channels that may be acquired. Other aspects, embodiments, and features are also claimed and described.

### CROSS REFERENCE TO RELATED APPLICATION & PRIORITY CLAIM

This application claims priority to and the benefit of U.S. Provisional Patent Application Ser. No. 61/550,589, filed Oct. 24, 2011, entitled “Systems and Methods for Improved & Enhanced Communication System Acquisition Using Mobile Receive Diversity (MRD)”; and U.S. Provisional Patent Application Ser. No. 61/556,809, filed Nov. 7, 2011, entitled “1× receive diversity during power up/initial acquisition and Out Of Service (OOS) & Enhanced Initial Acquisition and Out-of-Service with RxD.” Both of said applications are herein incorporated by reference as if fully set forth below and for all applicable purposes.

### TECHNICAL FIELD

Embodiments of the present invention relate generally to communication systems, and more particularly, to selectively invoking receive diversity during power-up/initial acquisition and out of service modes.

### BACKGROUND

Wireless communications systems are widely deployed to provide various types of communication content such as voice, video, packet data, messaging, broadcast, and so on. These systems may be accessed by wireless devices of multiple users sharing the available system resources (e.g., time, frequency, and power). Examples of such wireless communications systems include code-division multiple access (CDMA) systems, time-division multiple access (TDMA) systems, frequency-division multiple access (FDMA) systems, 3GPP Long Term Evolution (LTE) systems, and orthogonal frequency-division multiple access (OFDMA) systems.

Generally, a wireless device may be used to receive voice and/or data communications through the wireless communication systems. When receiving data communications, it is generally desirable to have relatively high data rates for communications to and from the wireless devices in order to enhance user experience. One commonly used technique to increase data rates uses multiple receive and/or transmit chains to receive and/or send data communications on multiple wireless communications channels simultaneously. Often, data is sent from a wireless device using a single transmit chain using a primary antenna that operates in duplex with a receive chain that uses the primary antenna, and a second receive chain, commonly referred to as a diversity receive chain, that uses a secondary antenna.

The use of multiple transmit and/or receive chains is effective in enhancing user experience through higher data transmission rates. However, the use of multiple transmit and/or receive chains may also adversely impact power consumption in the wireless device. Such wireless devices are generally battery operated, and it is desirable to increase the amount of time a wireless device can operate using only battery power.

### BRIEF SUMMARY OF SOME EMBODIMENTS

The following presents a simplified summary of one or more aspects of a method and apparatus for selectively invoking receive diversity during power-up/initial acquisition and out of service modes in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to various aspects, the subject innovation relates to apparatus and methods that provide wireless communications, where a method for wireless communications includes enabling a first receive chain in an attempt to acquire a first channel; and selectively enabling a second receive chain based on a result of the attempt.

Further, according to various aspects, the subject innovation relates to apparatus and methods that provide wireless communications, where a method for wireless communications includes enabling at least two receive chains in a wireless device to capture a first channel parameter for a channel from each of the at least two receive chains; determining at least one threshold related to the first channel parameter; and performing acquisition of the channel using MRD based on the captured first channel parameter from each of the at least two receive chains and the at least one threshold.

Further still, according to various aspects, the subject innovation relates to apparatus and methods that provide wireless communications, where a method for wireless communications includes determining a list of channels to be acquired by a wireless device comprising MRD capability, the list of channels comprising a subset of channels previously acquired by the wireless device; and attempting acquisition of a channel by initially disabling the MRD capability of the wireless device if the channel is in the subset of channels.

Further still, according to various aspects, the subject innovation relates to apparatus and methods that provide wireless communications, where an apparatus for wireless communication includes a memory; at least one processor coupled to the memory and configured to enable at least two receive chains in a wireless device to capture a first channel parameter for a channel from each of the at least two receive chains; determine at least one threshold related to the first channel parameter; and perform acquisition of the channel using Mobile Receive Diversity (MRD) based on the captured first channel parameter from each of the at least two receive chains and the at least one threshold.

Further still, according to various aspects, the subject innovation relates to apparatus and methods that provide wireless communications, where an apparatus for wireless communication includes a memory; at least one processor coupled to the memory and configured to enable a first receive chain in an attempt to acquire a first channel; and selectively enable a second receive chain based on a result of the attempt.

Further still, according to various aspects, the subject innovation relates to apparatus and methods that provide wireless communications, where an apparatus for wireless communication includes a memory; at least one processor coupled to the memory and configured to determine a list of channels to be acquired by a wireless device comprising Mobile Receive Diversity (MRD) capability, the list of channels comprising a subset of channels previously acquired by the wireless device; and attempt acquisition of a channel by initially disabling the MRD capability of the wireless device if the channel is in the subset of channels.

Further still, according to various aspects, the subject innovation relates to apparatus and methods that provide wireless communications, where an apparatus for wireless communication includes means for enabling at least two receive chains in a wireless device to capture a first channel parameter for a channel from each of the at least two receive chains; means for determining at least one threshold related to the first channel parameter; and means for performing acquisition of the channel using Mobile Receive Diversity (MRD) based on the captured first channel parameter from each of the at least two receive chains and the at least one threshold.

Further still, according to various aspects, the subject innovation relates to apparatus and methods that provide wireless communications, where an apparatus for wireless communication includes means for enabling a first receive chain in an attempt to acquire a first channel; and means for selectively enabling a second receive chain based on a result of the attempt.

Further still, according to various aspects, the subject innovation relates to apparatus and methods that provide wireless communications, where an apparatus for wireless communication includes means for determining a list of channels to be acquired by a wireless device comprising Mobile Receive Diversity (MRD) capability, the list of channels comprising a subset of channels previously acquired by the wireless device; and means for attempting acquisition of a channel by initially disabling the MRD capability of the wireless device if the channel is in the subset of channels.

Further still, according to various aspects, the subject innovation relates to a computer program product for wireless communications including a machine-readable storage medium including code for enabling at least two receive chains in a wireless device to capture a first channel parameter for a channel from each of the at least two receive chains; determining at least one threshold related to the first channel parameter; and performing acquisition of the channel using Mobile Receive Diversity (MRD) based on the captured first channel parameter from each of the at least two receive chains and the at least one threshold.

Further still, according to various aspects, the subject innovation relates to a computer program product for wireless communications including a machine-readable storage medium including code for enabling a first receive chain in an attempt to acquire a first channel; and selectively enabling a second receive chain based on a result of the attempt.

Further still, according to various aspects, the subject innovation relates to a computer program product for wireless communications including a machine-readable storage medium including code for determining a list of channels to be acquired by a wireless device comprising Mobile Receive Diversity (MRD) capability, the list of channels comprising a subset of channels previously acquired by the wireless device; and attempting acquisition of a channel by initially disabling the MRD capability of the wireless device if the channel is in the subset of channels.

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects may be employed and the described aspects are intended to include all such aspects and their equivalents.

### BRIEF DESCRIPTION OF THE DRAWINGS

These and other sample aspects of the disclosure will be described in the detailed description that follow, and in the accompanying drawings, wherein:

FIG. 1 is a block diagram of a wireless communications system in which various aspects of selectively invoking MRD during initial acquisition approach may be implemented;

FIG. 2 is a block diagram of an exemplary wireless device configured in accordance with various aspects of the disclosed approach in which various aspects of the MRD invocation optimization approach may be implemented;

FIG. 3 is a block diagram of an exemplary receiver module of the wireless device of FIG. 2 according to some embodiments of the present invention;

FIG. 4 is a block diagram of an exemplary control module of the wireless device of FIG. 2 according to some embodiments of the present invention;

FIG. 5 is a flow diagram of an exemplary process for selectively invoking MRD during initial acquisition according to some embodiments of the present invention;

FIG. 6 is a flow diagram of another exemplary process for selectively invoking MRD during initial acquisition based on channel conditions according to some embodiments of the present invention;

FIG. 7 is a flow diagram of another exemplary process for selectively invoking MRD during initial acquisition based on channel conditions, where a receive chain may be favored for non-MRD operations according to some embodiments of the present invention;

FIG. 8 is a flow diagram of another exemplary process for selectively invoking MRD during initial acquisition based on channel conditions, where one or more channels may be skipped during the initial acquisition according to some embodiments of the present invention; and

FIG. 9 is a flow diagram of another exemplary process for selectively invoking MRD during initial acquisition based on historical conditions according to some embodiments of the present invention.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

In the following description, reference is made to the accompanying drawings in which is shown, by way of illustration, specific approaches in which the disclosure may be practiced. The approaches are intended to describe aspects of the disclosure in sufficient detail to enable those skilled in the art to practice the invention. Other approaches may be utilized and changes may be made to the disclosed approaches without departing from the scope of the disclosure. The following detailed description is not to be taken in a limiting sense, and the scope of the disclosure is defined only by the appended claims.

Elements described herein may include multiple instances of the same element. These elements may be generically indicated by a numerical designator (e.g., “110”) and specifically indicated by the numerical indicator followed by an alphabetic designator (e.g., “110A”) or a numeric indicator proceeded by a “dash” (e.g., “110-1”). For ease of following the description, for the most part element number indicators begin with the number of the drawing on which the elements are introduced or most fully discussed.

The following description provides examples, and is not limiting of the scope, applicability, or configuration set forth in the claims. Changes may be made in the function and arrangement of elements discussed without departing from the spirit and scope of the disclosure. Various aspects may omit, substitute, or add various procedures or components as appropriate. For instance, the methods described may be performed in an order different from that described, and various steps may be added, omitted, or combined. Also, features described with respect to certain aspects may be combined in other aspects.

The discussions herein may involve CDMA and Evolution-Data Optimized (EV-DO) protocols and systems as one example in order to indicate additional details of some aspects of the disclosed approaches. Another example is a complementary device enhancement known as simultaneous (1×) Voice and (EV-DO) Data (SV-DO) that enables CDMA2000 devices to access EV-DO packet data services while in an active 1× circuit-switch voice call. However, those of ordinary skill in the art will recognize that various aspects of the disclosed approach may be used and included in many other wireless communication protocols and systems for selectively invoking MRD for acquisition. In particular, several different approaches for determining when to invoke MRD, in order to improve acquisition performance in marginal or weak coverage areas, are used.

Spatial diversity is a known wireless communication technique where the wireless device uses multiple spatially separated antennas for communicating with other wireless devices. The signals communicated from each of the antennas may be combined in such a way so as to take advantage of the fact that the different position of each antenna means that it is relatively unlikely that all antennas would be in a deep fade at the same time. Thus, the probability of encountering reduced wireless performance due to moving into a location of a deep fade may be dramatically reduced. In cdma2000 1× (1×) terminology, such a scheme is referred to as Mobile Receive Diversity (MRD).

For many devices today, when the wireless device initially powers up, or when the wireless device returns from being in a mode referred to as an Out-Of-Service (OOS) mode, the wireless device may only use one receive chain to attempt to acquire a system and establish communications with the cellular network. In wireless devices having more than one receive chain and configured to enable MRD, if each of the receive chains is utilized to attempt to acquire the system, the probability of acquisition may be increased. However, there is an associated cost to achieving the improved probability of acquisition, in that using additional receive chains may result in an increase in power consumption, degrading standby time of the battery-powered mobile device. Thus, there remains a need to intelligently invoke MRD during system acquisition.

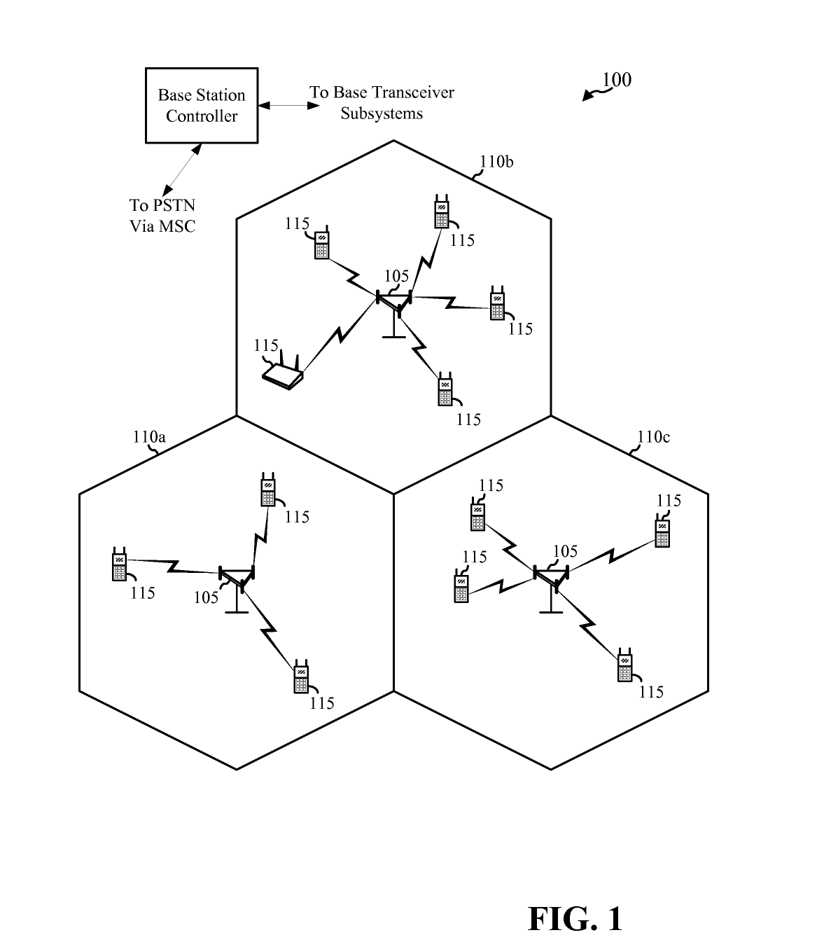

FIG. 1 is a block diagram illustrating an example of a wireless communications system 100. The system 100 includes base stations 105, wireless devices 115, and a base station controller 120, and a core network 125 (the controller 120 may be integrated into the core network 125). The system 100 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data, etc. The system 100 may be a multi-carrier LTE network capable of efficiently allocating network resources.

The base stations 105 may wirelessly communicate with the wireless devices 115 via a base station antenna. The base stations 105 are configured to communicate with the wireless devices 115 under the control of the controller 120 via multiple carriers. Each of the base station 105 sites can provide communication coverage for a respective geographic area. The coverage area 110 for each base station 105 here is identified as 110-a, 110-b, or 110-c. The coverage area 110 for a base station 105 may be divided into sectors (not shown, but making up only a portion of the coverage area). The system 100 may include base stations 105 of different types (e.g., macro, micro, and/or pico base stations).

The wireless devices 115 may be dispersed throughout the coverage areas 110. The wireless devices 115 may be referred to as wireless stations, mobile devices, access terminals (ATs), user equipments (UEs) or subscriber units. The wireless devices 115 may include cellular phones and wireless communications devices, but may also include personal digital assistants (PDAs), other handheld devices, netbooks, notebook computers, etc.

Different network scaling down modes can be considered depending on the network types and service goals. There are various ways of utilizing the channel and spatial resources in the network. Consider a wireless network that has multiple carriers over different sites. Different carriers can be used all for a single radio access technology (RAT) or multiple radio access technologies (multi-RAT) (e.g., N1 Universal Mobile Telecommunications System (UMTS) carriers and N2 Global System for Mobile Communications (GSM) carriers). Different modalities of scaling down the carrier and site dimensions may be defined.

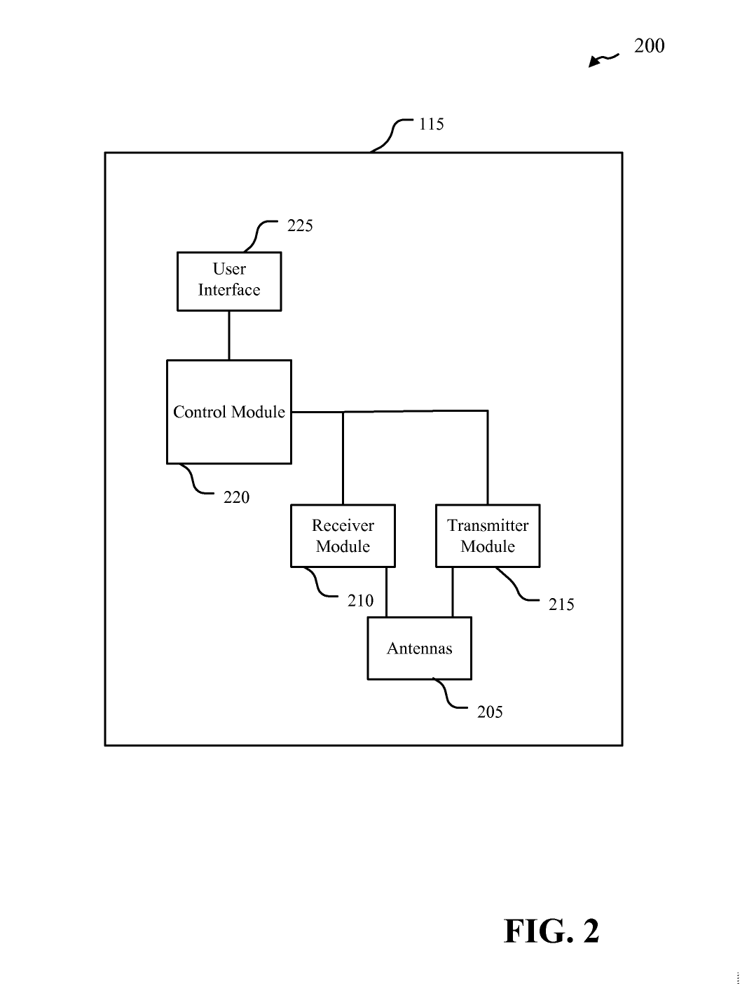

FIG. 2 is a block diagram illustration of an exemplary wireless device 115. The wireless device 115 may have any number of different configurations, such as personal computers (e.g., laptop computers, netbook computers, tablet computers, etc.), cellular telephones, PDAs, digital video recorders (DVRs), internet appliances, gaming consoles, e-readers, etc. The wireless device 115 may have a mobile configuration, having an internal power supply (not shown), such as a battery, to facilitate mobile operation. The wireless device 115 includes two or more antennas 205, which may be used in the transmission/reception of wireless communications to/from the wireless device 115. In some aspects of the disclosure, the antennas 205 include a primary antenna and a secondary antenna, with the primary antenna used for transmission and reception of wireless communications on a wireless communications channel, and the secondary antenna used for reception of wireless communications on a different wireless communications channel. In some devices, wireless communications can be received on more than two wireless communications channels, with such devices including additional antennas as necessary to receive wireless communications on three or more different wireless communications channels.

A receiver module 210 and a transmitter module 215 are coupled to the antennas 205. The receiver module 210 receives signals from the antennas, demodulates and processes the signals, and provides the processed signals to a control module 220. Similarly, the transmitter module 215 receives signals from the control module 220, processes and modulates the signals and transmits the processed and modulated signals using the antennas 205. In some aspects of the disclosure, the transmitter module 215 and receiver module 210 may be incorporated into a single transceiver module. The control module 220 performs processing tasks related to the operation of the wireless device 115, and is coupled to a user interface 225 that allows a user of the wireless device 115 to select various functions, control, and interact with the wireless device 115. The various components the wireless device 115 may be in communication with some or all of the other components of the wireless device 115 via one or more busses, for example.

Various aspects of the disclosed approach may be implemented with the components illustrated in FIGS. 1-2. Indeed, aspects of the disclosed approach may be implemented within and positioned within wireless communication devices such as those discussed above. Also, aspects of the disclosed approach may include circuits and components capable of carrying out the described algorithms in the flow charts described herein as well as the below discussed actions.

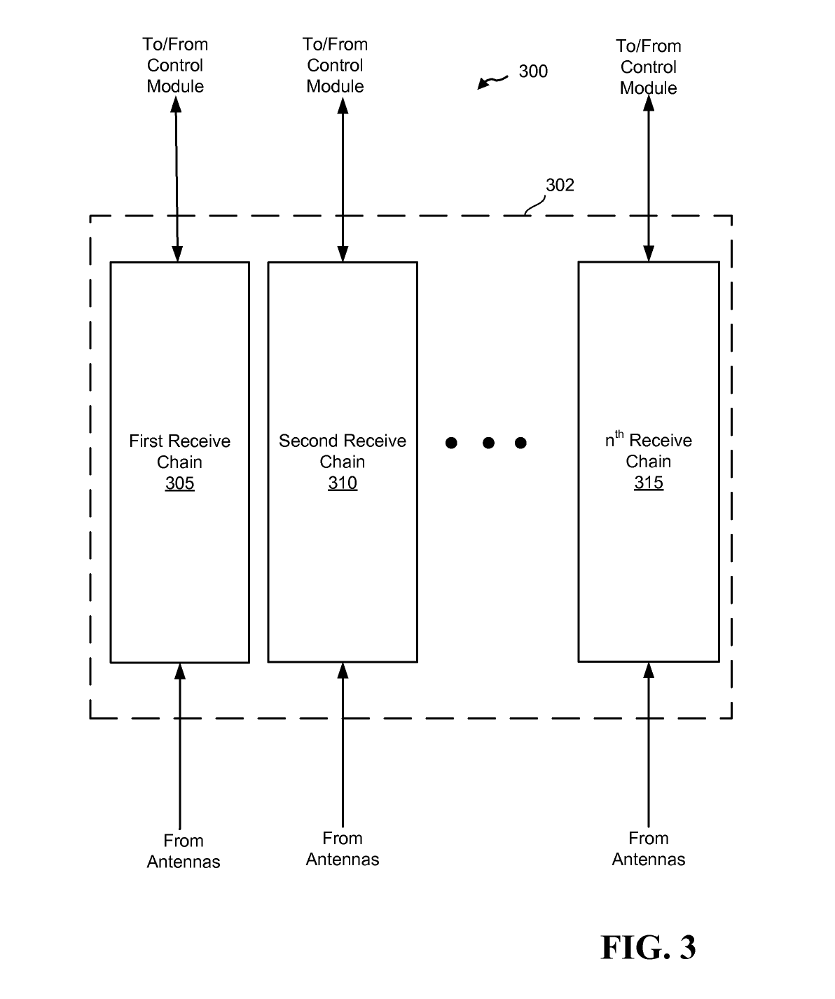

FIG. 3 is a block diagram illustration of an exemplary receiver module 300 that may be used to implement the receiver module 210 of mobile device 200. The receiver module 300 of FIG. 3 includes multiple receive chains 302 including a first receive chain 305, and a second receive chain 310 through an n^{th} receive chain 315. Each of the receive chains 305, 310-315 are coupled to a respective antenna in a group of antennas 205 and receive wireless communications signals from the group of antennas 205. The first receive chain 305, for example, may be coupled to a primary antenna of the group of antennas 205 in the wireless device 200 and share the primary antenna with the transmitter module 215. The second receive chain 310 through the n^{th} receive chain 315, in some aspects of the disclosure, are coupled to a respective one of the secondary antennas in the group of antennas 205 to provide an enhanced mode for reception of data at the wireless device using RxD. Each of the receive chains 305, 310-315 include components that are used in such receive chains to perform such tasks as related to reception and filtering of incoming signals, frequency conversion and gain control, and baseband processing to provide a digital output to the control module 220. Such components are well understood and need not be described in detail here. In various aspects of the disclosed approach, as will be described in more detail below, each of the first receive chain 305 and the second receive chain 310 through n^{th} receive chain 315, may be enabled and disabled under certain conditions to reduce overall power consumption of the wireless device 200.

As used herein, a “receive chain” may refer to a combination of an antenna and a receive circuit of a wireless device where the wireless device includes multiple receive circuitries, each paired to an antenna. Where the wireless device includes multiple antennas but only a single receive circuit, the “receive chain” may also refer to a configuration where the single receive circuit may be coupled to a selected one of the antennas that is currently active. Reference to several examples below will be made using two exemplary receive chains, with the understanding that more than two receive chains may be present in a receiver module 210, as illustrated in the exemplary receiver module 300 in FIG. 3, and that only two receive chains are described in various examples for a more simplified discussion and illustration of the concept.

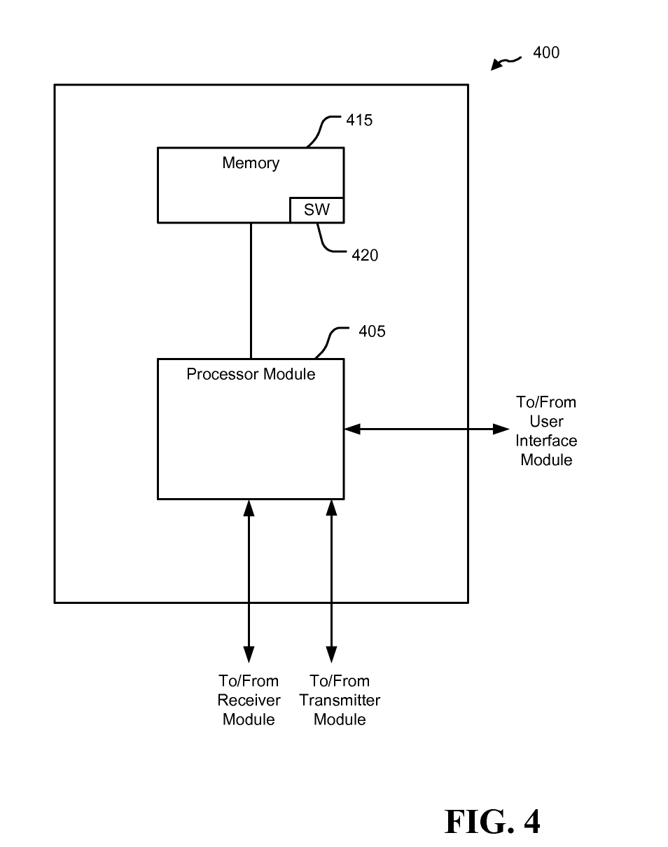

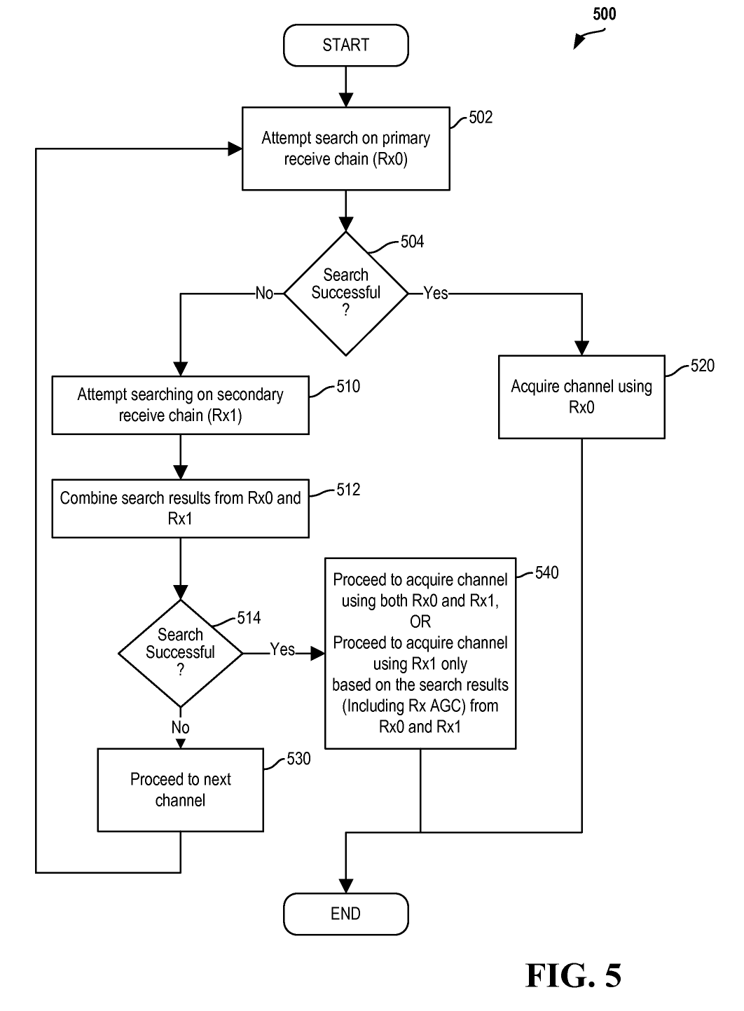

FIG. 4 illustrates a control module 400 that may be used to implement the control module 220 of the wireless device 200 according to some aspects of the disclosed approach. The control module 400 includes a processor module 405. The control module 400 also may include a memory 415. As non-limiting examples, the memory 415 may include Random Access Memory (RAM), Read-Only Memory (ROM), Non-Volatile Random Access Memory (NVRAM), or combinations thereof. The memory 415 may store computer-readable, computer-executable software code 420 containing instructions that are configured to, when executed, cause the processor module 405 to perform various functions of the wireless device 200 (e.g., call processing, message routing, execution of applications, etc.). Alternatively, the software code 420 may not be directly executable by the processor module 405 but may be configured to cause the processor module 405 (e.g., when compiled and executed) to perform functions described herein, such as the processes shown in FIGS. 5-9. The software code 420 may also, when executed, cause the processor module 405 to track and record historical usage data relating to, for example, the communications characteristics of the packets received and transmitted by the wireless device 200. The historical communications data may be stored in memory 415 and accessed and updated as needed by the processor module 405.

The processor module 405 may include an intelligent hardware device, e.g., a central processing unit (CPU) such as those made by Intel® Corporation or AMD®, a microcontroller, an application specific integrated circuit (ASIC), etc. The processor module 405 may include a speech encoder (not shown) configured to receive audio via a microphone, convert the audio into packets representative of the received audio, provide the audio packets to the transmitter module 215, and provide indications of whether a user is speaking. The processor module 405 may execute one or more applications that a user may access, through the user interface 225, to generate digital content that is to be transmitted from the wireless device 200. Such digital content may include email or text message communications, to name but two examples, that the processor module 405 may convert into data packets, and provide the data packets to the transmitter module 215.

FIG. 5 illustrates a first exemplary acquisition process 500 for invoking MRD based on acquisition search results, where a wireless device attempts system acquisition utilizing a primary receive chain first. If the acquisition attempt on the primary receive chain fails, then the wireless device may invoke acquisition on secondary receive chain, and combine search results from the primary and secondary receive chains.

At 502 an acquisition attempt in the acquisition process begins by attempting a search utilizing only the primary receive chain. That is, MRD is not used at the start of the acquisition attempt.

At 504, it is determined if the search is successful. If the search is unsuccessful, then the acquisition process may continue with 510. If the search is successful, then the device may proceed to acquire the channel utilizing the primary receive chain and the acquisition process continues with 520.

At 520, where it is determined that the search is successful at 504, then the wireless device may attempt to acquire the channel using the results of the search at 502.

At 510, if it is determined at 504 that the search at 502 fails, the acquisition process continues by attempting a search utilizing only the secondary receive chain.

At 512, the search results from the secondary receive chain may be combined with the search results from the primary receive chain. In one aspect of the disclosed approach, a suitable signal processing algorithm may be utilized to combine the search results from the primary and secondary receive chains. As referred to herein, the search mode implemented using the combined search results may be referred to as a pseudo diversity mode.

At 514, it is determined if the pseudo diversity mode search based on the combined search results from 512 is not successful, then the process continues with 530. Otherwise, if the combined search results is not successful, then the process continues with 540.

At 530, as the combined search results from 512 has been determined not to be successful, the search process 500 may proceed with the next channel, and the primary receive chain may be used to for an acquisition attempt on the next channel.

At 540, if the pseudo diversity mode search is successful, then based on the search results, the device may proceed to acquire the channel utilizing either both the primary and secondary receive chains, or in another aspect of the disclosed approach, using only the secondary receive chain.

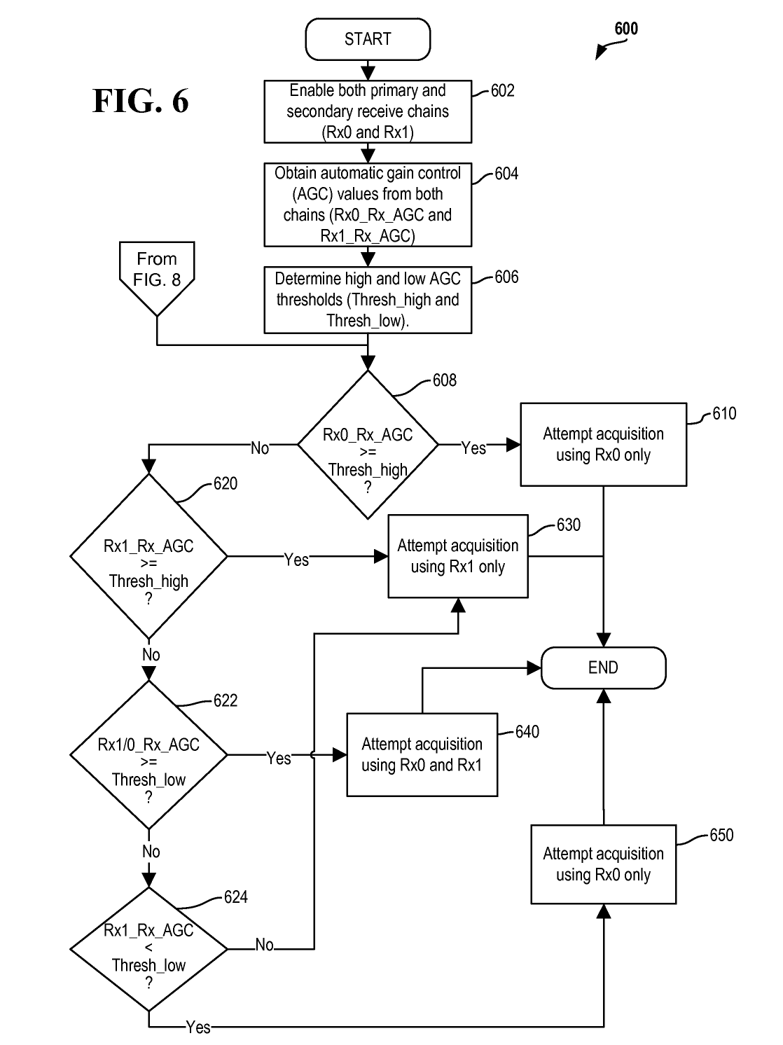

FIG. 6 illustrates another exemplary acquisition process 600 for invoking MRD based on automatic gain control (AGC) values, where a wireless device attempts system acquisition by first utilizing MRD and measuring the Rx AGC of the two receive chains. If the Rx AGC of the primary receive chain is sufficiently high, then the acquisition attempt may be performed using the primary receive chain only, and the secondary receive chain may be disabled. Conversely, if the Rx AGC of the secondary receive chain is sufficiently high, then an acquisition attempt may be made using the secondary receive chain, and the primary receive chain may be disabled. If both Rx AGC values are not sufficiently high but not sufficiently low—such as between a range of Rx AGC values, then acquisition may be attempted with MRD enabled. It should be noted that parameters such as received signal strength indication (RSSI) may be used instead of or in addition to AGC values.

The acquisition process 600 begins at 602, where both primary and secondary receive chains are enabled, and at 604, AGC values are obtained from both chains. The AGC is utilized to determine a received signal level and outputs a voltage, corresponding to the received signal level. Typically, the AGC value is used as feedback to adjust the gain in a receive amplifier. In one aspect of the disclosed approach, the AGC value is utilized to determine whether to enable one or both receive chains in the acquisition attempt.

At 606, two thresholds are set: a high threshold and a low threshold. In one aspect, several different options may be used for determining whether to utilize one or both receive chains in the acquisition attempt, based on the determined AGC values from each receive chain, and their respective relationship to these two thresholds (i.e., below the low threshold, between the two thresholds, or above the high threshold). In one aspect, it is desirable to use the primary receive chain as much as possible.

At 608, it is determined whether the AGC value of the primary receive chain is at least equal to the high threshold, as represented by the following expression:

Rx0_Rx_AGC>=Thresh_high, (1)

where Rx0_Rx_AGC is the AGC value of the primary receive chain, and Thresh_high is the high threshold. If so, then the acquisition process continues with 610. Otherwise, the acquisition process may continue with 620.

At 610, where it is determined that the AGC value of the primary receive chain is at least equal to the high threshold at 608, the wireless device may attempt acquisition using the primary receive chain only and the secondary receive chain may be disabled.

At 620, where it is determined whether the AGC value of the primary receive chain is less than the high threshold at 608, and the AGC of the secondary receive chain is at least equal to the high threshold, as represented by the following expression:

Rx0_Rx_AGC<Thresh_high

AND

Rx1_Rx_AGC>=Thresh_high, (2)

where Rx1_Rx_AGC is the AGC value of the secondary receive chain. If so, then the acquisition process continues with 630. Otherwise, the acquisition process continues with 622.

At 630, the wireless device may attempt acquisition on the secondary receive chain only and the primary receive chain may be disabled.

At 622, it is determined if the AGC values of the primary and secondary receive chains are both higher than the low threshold and lower than the high threshold, as represented by the following expression:

Thresh_low<=Rx0_Rx_AGC<Thresh_high

AND

Thresh_low<=Rx1_Rx_AGC<Thresh_high, (3)

where Thresh_low is the low threshold. Thus, it is determined if the AGC values of the primary and secondary receive chains are within a range as defined by the low threshold and the high threshold. If so, then the acquisition process may continue with 640. Otherwise, the acquisition process may continue with 624

At 640, the wireless device may attempt acquisition using both the primary and secondary receive chains.

At 624, where it has previously been determined that the AGC value of at least one of the primary and secondary receive chains is above the low threshold at 622, it is determined whether the AGC value of the secondary receive chain is below the threshold range, as represented by the expression:

Rx1_Rx_AGC<Thresh_low. (4)

In one aspect of the disclosed approach, the wireless device attempts to utilize the primary receive chain as much as possible. Thus, if it is determined that the AGC value of the secondary receive chain is below the low threshold, then regardless of whether the AGC value of the primary receive chain is above the low threshold, the acquisition process may continue with 650, where the wireless device may attempt to acquire the channel using only the primary receive chain. Otherwise, the acquisition process may return to 630, where the wireless device may attempt to acquire the channel using only the secondary receive chain, as previously discussed.

At 650, the wireless device may attempt acquisition on the primary receive chain only, and the secondary receive chain may be disabled.

A variant on the described approach may be that the determined AGC values may be used more simply. In one aspect of the disclosed approach, the AGC values may be used to determine which receive chain to use first for an acquisition attempt.

In another aspect of the disclosed approach, the Rx AGC values of the specific receive chain establish the sequence of using the chains in acquisition. Specifically, as an example, when the wireless devices starts with just one receive chain, if the acquisition attempt on that chain failed, then the other chain would be enabled. A search would be performed on the other chain, and the search results from the first receive chain and the other receive chain would be combined.

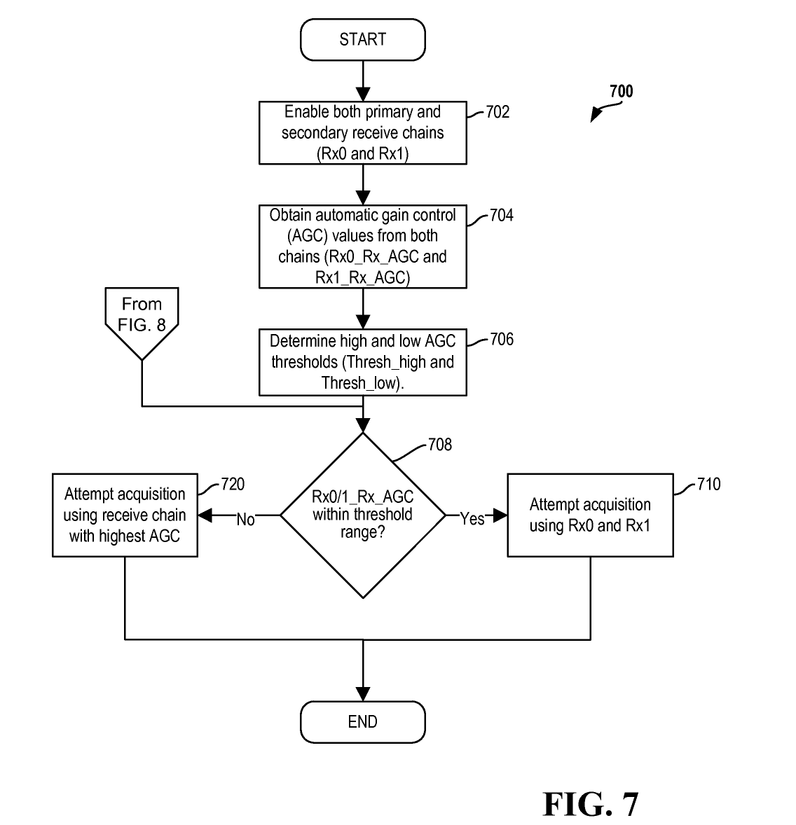

FIG. 7 illustrates another exemplary acquisition process 700 for invoking MRD based on AGC values, where the wireless device may attempt system acquisition given a preferential use of the receiver chain with the higher Rx AGC.

The acquisition process 700 begins at 702, where both primary and secondary receive chains are enabled, and at 704, AGC values are obtained from both chains, as discussed with regard to FIG. 6, above.

At 706, two thresholds are set: a high threshold and a low threshold. In one aspect, several different options may be used for determining whether to utilize one or both receive chains in the acquisition attempt, based on the determined AGC values from each receive chain, and their respective relationship to these two thresholds (i.e., below the low threshold, between the two thresholds, or above the high threshold).

At 708. it is determined if the AGC values of the primary and secondary receive chains are both higher than the low threshold and lower than the high threshold, as represented by the following expression:

Thresh_low<=Rx0_Rx_AGC<Thresh_high

AND

Thresh_low<=Rx1_Rx_AGC<Thresh_high. (5)

Thus, it is determined if the AGC values of the primary and secondary receive chains are within a range as defined by the low threshold and the high threshold. If so, then the acquisition process may continue with 710. Otherwise, the acquisition process may continue with 720

At 710, the wireless device may attempt acquisition in diversity mode using both the primary and secondary receive chains.

At 720, the wireless device may attempt acquisition on the receive chain with higher Rx AGC, and the other receive chain may be disabled.

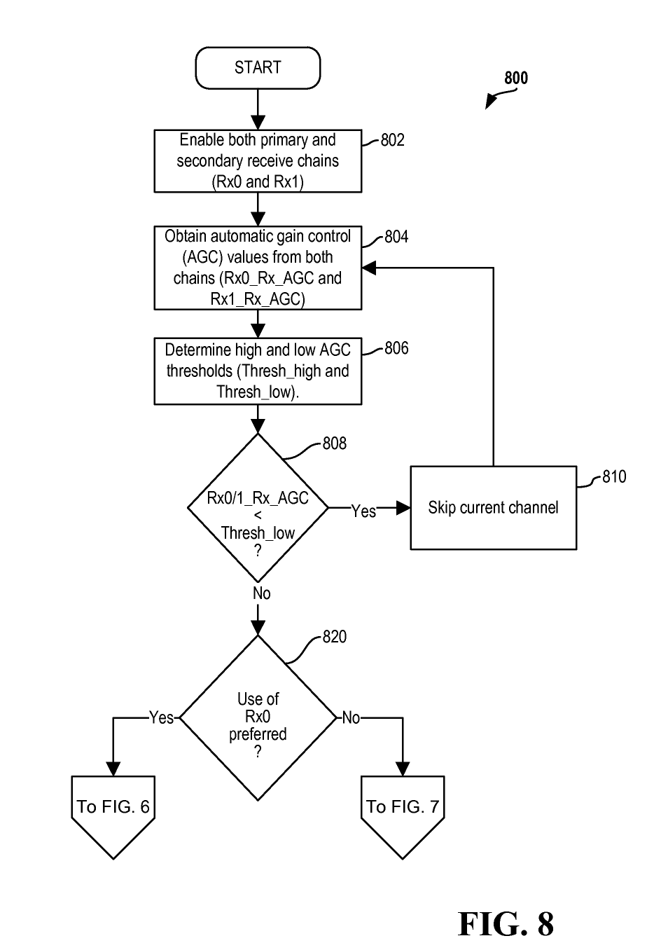

FIG. 8 illustrates another exemplary acquisition process 800 for invoking MRD based on AGC values, where the wireless device may attempt system acquisition given conditions for skipping channels on which no acquisition attempt may be made.

The acquisition process 800 begins at 802, where both primary and secondary receive chains are enabled, and at 804, AGC values are obtained from both chains.

At 806, two thresholds are set: a high threshold and a low threshold. In one aspect, several different options may be used for determining whether to utilize one or both receive chains in the acquisition attempt, based on the determined AGC values from each receive chain, and their respective relationship to these two thresholds (i.e., below the low threshold, between the two thresholds, or above the high threshold).

At 808, it is determined whether the AGC values of both the primary and secondary receive chains are less than the low threshold, as represented by the following expression:

Rx0_Rx_AGC<Thresh_low

AND

Rx1_Rx_AGC<Thresh_low. (6)

If so, then the acquisition process continues at 810. Otherwise, the process continues at 820.

At 810, the wireless device will skip the current channel, and the acquisition process returns to 804 with the next channel.

At 820, where it has been determined that the AGC values of at least one of the primary or secondary receive chains is at least above the low threshold, it is determined whether the use of the primary receive chain is preferred. If so, then the acquisition process may proceed with 608 of FIG. 6, where the wireless device may attempt to acquire the channel with a preference of using the primary receive chain. Otherwise, the acquisition process may proceed with 708 of FIG. 7, where the wireless device may attempt to acquire the channel using the receive chain with the higher AGC value.

In various aspects of the disclosed approach, the Rx AGC threshold under which a channel may be skipped may have certain dependencies. These dependencies include which chain(s) is(are) available, such as the primary receive chain only, the secondary receive chain only, or both the primary and secondary receive chains; a class of the band and channel, which may include a noise threshold that is based on the class of the bad and/or channel; an operating character of the wireless device, such as operating temperature, battery life, etc.; and a noise floor of each available receive chain.

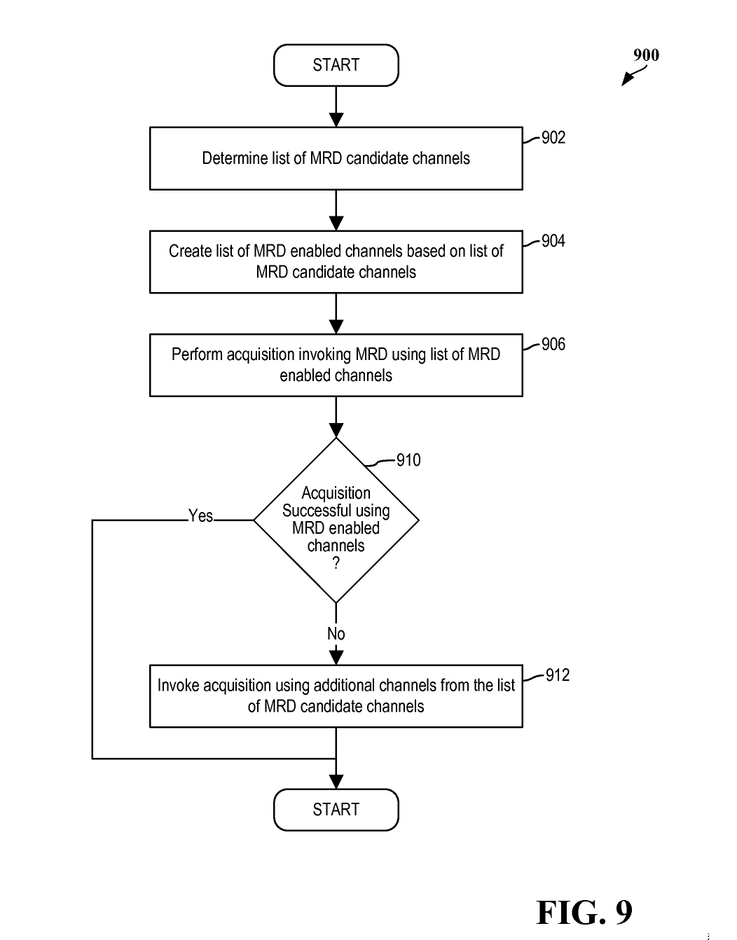

FIG. 9 illustrates another exemplary acquisition process 900 for invoking MRD based on history, where a wireless device attempts system acquisition on channels on which the wireless device has previously camped. In one aspect of the disclosed approach, the acquisition process is optimized for power consumption during acquisition, and exemplifies a willingness to increase power consumption on the most promising channels based on history.

At 902, the wireless device may determine a list of MRD candidate channels, which are channels over which the wireless device may activate MRD. In one aspect of the disclosed approach, the list of MRD candidate channels is based on a list of “most recently used” (MRU) channels on which the wireless device has camped before. Further enhancement is possible if device may record the transitions from one channel/system to the next channel/system in the usage history of the device/technology. Transitions may further be divided/qualified by power ON/OFF, system lost, and airplane mode ON/OFF statistics. For example, although the list of MRD candidate channels may be based restricted to a preferred roaming list (PRL), at a given location, most of the channels on the PRL are not active, and it may be more efficient to not enable MRD on these channels.

In one aspect of the disclosed approach, the wireless device may be the entity that stores the information used to construct the list of MRD candidate channels. For example, the wireless device may store information such as the list of MRU channels. In another aspect of the disclosed approach, the wireless device may be provided with the list of MRU channels.

At 904, the wireless device may create a list of MRD enabled channels based on the list of MRD candidate channels. The channels in the list of MRD enabled channels may be selected from the list of MRD candidate channels based on a variety of criteria. Selectivity may be as strict as restricting the wireless device to only consider enabling MRD for the last channel/system on which the wireless device camped (i.e., MRU[0]). This may be further generalized as restricting use of the MRD for a list consisting of the top N MRU channels/systems on which the wireless device has previously camped (i.e., MRU[0 to N−1]). In OOS scenarios, MRD may be restricted to the channel/system that the device/technology last camped on (channel/system X) as well as channels/systems that the wireless device transitioned from X before in usage history. Further, how often MRD is invoked, may be set higher or lower based on how many of the most recently used channels are used. For example, in a highly restrictive approach, only the most recent channel or system on which the wireless device was camped might result in MRD being invoked; while a less restrictive approach might invoke MRD based on a large number of most recently used channels or systems.

At 906, the wireless device may invoke MRD for the list of MRD enabled channels determined at 904. In addition to using the list of MRD enabled channels, the wireless device may also restrict MRD based on one or more of these factors:
whether the wireless device is acquiring a home system or not;
whether the wireless device is acquiring a system or channel from which the wireless device transitioned that is the most recent entry in the MRU list; or
usage history: is the search happening after power off/on, or airplane mode being turned off/on; or was the system lost/call dropped.

In one aspect of the disclosed approach, the acquisition process may include attempting to perform acquisition without using MRD, and then, if the acquisition fails, then enabling MRD to perform acquisition for the same channel before attempting acquisition for a next channel. Thus, the wireless device may attempt acquisition using non-MRD and MRD for each channel. Alternatively, in a device that is not capable of dynamically turning MRD on and off, an approach may begin by initially scanning the list of MRD enabled channels with MRD turned off. Here, if all scans fail, the wireless device may then scan the MRU channels with MRD enabled. Further, if all scans fail once again, the acquisition process may continue by scanning remaining channels in the preferred roaming list (PRL) (i.e., those channels in the PRL that are not in the MRU list) with MRD disabled. If these scans fail, the wireless device may scan those remaining channels in the PRL with MRD enabled. Further still, the wireless device may scan any other channels with the MRD disabled before attempting to scan these channels with the MRD enabled.

At 910, it is determined if acquisition is successful using the list of MRD enabled channels, as described above. If not, then the acquisition process may continue with 912. Otherwise, the acquisition process may terminate.

At 912, the wireless device may invoke acquisition using additional channels from the list of MRD candidate channels where acquisition failed at 906. In addition, as discussed above, the wireless device may attempt acquisition using other channels. The acquisition attempts may use MRD as described above.

As discussed, various aspects of the disclosed approach address the above issues and other issues in a variety of fashions. For example, aspects of the disclosed approach include methods that attempt system acquisition on a primary receive chain initially, and if acquisition failed, invoke acquisition on a secondary receive chain and combine search results from the primary and secondary receive chains. It should be noted that the reference to a secondary receive chain should not be limited to a single secondary receive chain, but may encompass several additional receive chains. Various aspects of the disclosed approach may also include first measuring one or more channel characteristics, such as the AGC of each of the receive chains and decide that if one or more receive chains are to be used in the acquisition attempt. If acquisition on a particular receive chain fails, then MRD may be invoked. It may also be determined that both receive chains are compromised, but MRD would assist in acquisition, and MRD would be invoked for system acquisition.

The processing system described herein, or any part of the processing system, may provide the means for performing the functions recited herein. Alternatively, the code on the computer-readable medium may provide the means for performing the functions recited herein.

In some conditions, it may always be advisable to use multiple receive chains. As a non-limiting example, it may be advisable to enable multiple receive chains for the current control interval when the wireless device 200 could not successfully decode the control channel during the previous control interval. An inability to successfully decode the control channel during the previous control interval may indicate a very weak signal and the wireless device 200 is in danger of losing coverage. In such a case, power consumption may be of a lesser concern than maintaining connection with the base station 105. Thus, past communications information could include past performance information that may or may not take into account the number of receive chains that were enabled in the attempt to decode the control channel during the previous control interval.

Other conditions where the use of multiple receive chains may be advisable, but not necessarily related to control intervals, are during initial acquisition when a single receive chain failed to acquire the channel in the last round, or when a Radio Signal Strength Indicator (RSSI) indicates a very low power signal (e.g., lower than about −100 dBm). These conditions may also be applicable for an initial acquisition, such that multiple receive chains may be enabled when the RSSI is low or if a decoding process failed with a single receive chain in the previous initial acquisition.

One or more of the components, acts, features and/or functions described herein and illustrated in the drawings may be rearranged and/or combined into a single component, act, feature, or function or embodied in several components, acts, features, or functions. Additional elements, components, acts, and/or functions may also be added without departing from the invention. The algorithms described herein may also be efficiently implemented in software and/or embedded in hardware.

In the description, elements, circuits, and functions may be shown in block diagram form in order not to obscure the disclosed approach in unnecessary detail. Conversely, specific implementations shown and described are exemplary only and should not be construed as the only way to implement the disclosed approach unless specified otherwise herein. Additionally, block definitions and partitioning of logic between various blocks is exemplary of a specific implementation. It is readily apparent to one of ordinary skill in the art that the disclosed approach may be practiced by numerous other partitioning solutions. For the most part, details concerning timing considerations and the like have been omitted where such details are not necessary to obtain a complete understanding of the disclosed approach and are within the abilities of persons of ordinary skill in the relevant art.

Also, it is noted that the aspects may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of ordinary skill in the art would understand that information and signals may be represented using any of a variety of different technologies and techniques. For example, data, instructions, commands, information, signals, bits, symbols, and chips that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the disclosed approach may be implemented on any number of data signals, including a single data signal.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium,” “computer-readable medium,” and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium,” “computer-readable medium,” and/or “processor-readable medium” and executed by one or more processors, machines and/or devices.

Furthermore, aspects may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration. A general-purpose processor, configured for executing aspects described herein, is considered a special purpose processor for carrying out such aspects. Similarly, a general-purpose computer is considered a special purpose computer when configured for carrying out aspects described herein.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware, software, or a combination thereof depends upon the particular application and design selections imposed on the overall system.

The various features of the invention described herein can be implemented in different systems without departing from the invention. It should be noted that the foregoing aspects are merely examples and are not to be construed as limiting the invention. The description of the aspects is intended to be illustrative, and not to limit the scope of the claims. As such, the present teachings can be readily applied to other types of apparatuses and many alternatives, modifications, and variations will be apparent to those skilled in the art.

The previous description is provided to enable any person skilled in the art to fully understand the full scope of the disclosure. Modifications to the various configurations disclosed herein will be readily apparent to those skilled in the art. Thus, the claims are not intended to be limited to the various aspects of the disclosure described herein, but is to be accorded the full scope consistent with the language of claims, wherein reference to an element in the singular is not intended to mean “one and only one” unless specifically so stated, but rather “one or more.” Unless specifically stated otherwise, the term “some” refers to one or more. A claim that recites at least one of a combination of elements (e.g., “at least one of A, B, or C”) refers to one or more of the recited elements (e.g., A, or B, or C, or any combination thereof). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication comprising:
enabling at least two receive chains in a wireless device to capture a first channel parameter for a channel from each of the at least two receive chains;
determining at least one threshold related to the first channel parameter; and
performing acquisition of the channel using Mobile Receive Diversity (MRD) based on the captured first channel parameter from each of the at least two receive chains and the at least one threshold.

2. The method of claim 1, wherein the performing the acquisition using MRD comprises:
attempting an acquisition of the channel using one of the at least two receive chains; and
attempting, based on a result of the acquisition of the channel using the one of the at least two receive chains, another acquisition using another one or more of the at least two receive chains.

3. The method of claim 2, wherein the attempting of the other acquisition comprises:
performing a search for the channel utilizing the other one of the at least two receive chains; and
combining the results of the acquisition attempt of the first channel using the one of the at least two receive chains with the search for the channel utilizing the other one of the at least two receive chains.

4. The method of claim 1, wherein the first channel parameter comprises an Automatic Gain Control (AGC).

5. The method of claim 1, wherein the at least one threshold comprises a range comprising a high threshold and a low threshold.

6. The method of claim 5, wherein the at least two receive chains comprises a first receive chain and a second receive chain, and wherein the performing of the acquisition of the channel using MRD comprises:
determining if the captured first channel parameter for the first receive chain is within the range of the at least one threshold; and
enabling the first receive chain based on the determination.

7. The method of claim 6, wherein the performing of the acquisition of the wireless communication system using MRD further comprises:
determining if the captured first channel parameter for the second receive chain is within the range of the at least one threshold; and
enabling the second receive chain based on the determination.

8. The method of claim 6, wherein the first receive chain is a primary receive chain and the second receive chain is a secondary receive chain.

9. The method of claim 6, wherein only one of the first receive chain and the second receive chain is used in the acquisition.

10. The method of claim 1, wherein the performing the acquisition using MRD comprises:
skipping an attempt for acquisition of the channel based on a determination that the captured first channel parameter from each of the at least two receive chains is not above the at least one threshold.

11. A method for wireless communication comprising:
enabling a first receive chain in an attempt to acquire a first channel; and
selectively enabling a second receive chain based on a result of the attempt.

12. The method of claim 11, further comprising:
storing information obtained from the attempt of the first receive chain; and
utilizing the stored information during an second attempt to acquire the first channel using the second receive chain.

13. The method of claim 12, wherein the utilizing of the stored information comprises:
combining the stored information with information obtained during the second attempt to acquire the first channel using the second receive chain; and
utilizing the combined information in the second attempt to acquire the first channel.

14. The method of claim 11, further comprising:
attempting to acquire a second channel using the first receive chain based on a failure of acquisition of the first channel; and
selectively enabling the second receive chain to attempt to acquire the second channel based on a result of the acquisition of the second channel.

15. A method for wireless communication comprising:
determining a list of channels to be acquired by a wireless device comprising Mobile Receive Diversity (MRD) capability, the list of channels comprising a subset of channels previously acquired by the wireless device; and
attempting acquisition of a channel by initially disabling the MRD capability of the wireless device if the channel is in the subset of channels.

16. The method of claim 15, wherein the attempting of the acquisition comprises:
using only a first receive chain to acquire the channel as a first attempt to acquire the channel; and
performing a second attempt at the acquisition of the channel using a second receive chain based on the first attempt to acquire the channel.

17. The method of claim 15, wherein the subset of channels comprises a Most Recently Used (MRU) list of channels.

18. The method of claim 15, wherein the list of channels comprises a Preferred Roaming List (PRL).

19. An apparatus for wireless communication comprising:
a memory;
at least one processor coupled to the memory and configured to:
enable at least two receive chains in a wireless device to capture a first channel parameter for a channel from each of the at least two receive chains;
determine at least one threshold related to the first channel parameter; and
perform acquisition of the channel using Mobile Receive Diversity (MRD) based on the captured first channel parameter from each of the at least two receive chains and the at least one threshold.

20. The apparatus of claim 19, wherein the at least one processor is further configured to:
attempt an acquisition of the channel using one of the at least two receive chains; and
attempt, based on a result of the acquisition of the channel using the one of the at least two receive chains, another acquisition using another one or more of the at least two receive chains.

21. The apparatus of claim 20, wherein the at least one processor is further configured to:
perform a search for the channel utilizing the other one of the at least two receive chains; and
combine the results of the acquisition attempt of the first channel using the one of the at least two receive chains with the search for the channel utilizing the other one of the at least two receive chains.

22. The apparatus of claim 19, wherein the first channel parameter comprises an Automatic Gain Control (AGC).

23. The apparatus of claim 19, wherein the at least one threshold comprises a range comprising a high threshold and a low threshold.

24. The apparatus of claim 23, wherein the at least two receive chains comprises a first receive chain and a second receive chain, and wherein the at least one processor is further configured to:
determine if the captured first channel parameter for the first receive chain is within the range of the at least one threshold; and
enable the first receive chain based on the determination.

25. The apparatus of claim 24, wherein the at least one processor is further configured to:
determine if the captured first channel parameter for the second receive chain is within the range of the at least one threshold; and
enable the second receive chain based on the determination.

26. The apparatus of claim 24, wherein the first receive chain is a primary receive chain and the second receive chain is a secondary receive chain.

27. The apparatus of claim 24, wherein only one of the first receive chain and the second receive chain is used in the acquisition.

28. The apparatus of claim 19, wherein the at least one processor is further configured to:
skip an attempt for acquisition of the channel based on a determination that the captured first channel parameter from each of the at least two receive chains is not above the at least one threshold.

29. An apparatus for wireless communication comprising:
a memory;
at least one processor coupled to the memory and configured to:
enable a first receive chain in an attempt to acquire a first channel; and
selectively enable a second receive chain based on a result of the attempt.

30. The apparatus of claim 29, wherein the at least one processor is further configured to:
store information obtained from the attempt of the first receive chain; and
utilize the stored information during an second attempt to acquire the first channel using the second receive chain.

31. The apparatus of claim 30, wherein the at least one processor is further configured to:
combine the stored information with information obtained during the second attempt to acquire the first channel using the second receive chain; and
utilize the combined information in the second attempt to acquire the first channel.

32. The apparatus of claim 29, wherein the at least one processor is further configured to:
attempt to acquire a second channel using the first receive chain based on a failure of acquisition of the first channel; and
selectively enable the second receive chain to attempt to acquire the second channel based on a result of the acquisition of the second channel.

33. An apparatus for wireless communication comprising:
a memory;
at least one processor coupled to the memory and configured to:
determine a list of channels to be acquired by a wireless device comprising Mobile Receive Diversity (MRD) capability, the list of channels comprising a subset of channels previously acquired by the wireless device; and
attempt acquisition of a channel by initially disabling the MRD capability of the wireless device if the channel is in the subset of channels.

34. The apparatus of claim 33, wherein the at least one processor is further configured to:
use only a first receive chain to acquire the channel as a first attempt to acquire the channel; and
perform a second attempt at the acquisition of the channel using a second receive chain based on the first attempt to acquire the channel.

35. The apparatus of claim 33, wherein the subset of channels comprises a Most Recently Used (MRU) list of channels.

36. The apparatus of claim 33, wherein the list of channels comprises a Preferred Roaming List (PRL).

37. An apparatus for wireless communication comprising:
means for enabling at least two receive chains in a wireless device to capture a first channel parameter for a channel from each of the at least two receive chains;
means for determining at least one threshold related to the first channel parameter; and
means for performing acquisition of the channel using Mobile Receive Diversity (MRD) based on the captured first channel parameter from each of the at least two receive chains and the at least one threshold.

38. The apparatus of claim 37, wherein the means for performing the acquisition using MRD comprises:
means for attempting an acquisition of the channel using one of the at least two receive chains; and
means for attempting, based on a result of the acquisition of the channel using the one of the at least two receive chains, another acquisition using another one or more of the at least two receive chains.

39. The apparatus of claim 38, wherein the means for attempting of the other acquisition comprises:
means for performing a search for the channel utilizing the other one of the at least two receive chains; and
means for combining the results of the acquisition attempt of the first channel using the one of the at least two receive chains with the search for the channel utilizing the other one of the at least two receive chains.

40. The apparatus of claim 37, wherein the first channel parameter comprises an Automatic Gain Control (AGC).

41. The apparatus of claim 37, wherein the at least one threshold comprises a range comprising a high threshold and a low threshold.

42. The apparatus of claim 41, wherein the at least two receive chains comprises a first receive chain and a second receive chain, and wherein the means for performing of the acquisition of the channel using MRD comprises:
means for determining if the captured first channel parameter for the first receive chain is within the range of the at least one threshold; and
means for enabling the first receive chain based on the determination.

43. The apparatus of claim 42, wherein the means for performing of the acquisition of the wireless communication system using MRD further comprises:
means for determining if the captured first channel parameter for the second receive chain is within the range of the at least one threshold; and
means for enabling the second receive chain based on the determination.

44. The apparatus of claim 42, wherein the first receive chain is a primary receive chain and the second receive chain is a secondary receive chain.

45. The apparatus of claim 42, wherein only one of the first receive chain and the second receive chain is used in the acquisition.

46. The apparatus of claim 37, wherein the means for performing the acquisition using MRD comprises:
means for skipping an attempt for acquisition of the channel based on a determination that the captured first channel parameter from each of the at least two receive chains is not above the at least one threshold.

47. An apparatus for wireless communication comprising:
means for enabling a first receive chain in an attempt to acquire a first channel; and
means for selectively enabling a second receive chain based on a result of the attempt.

48. The apparatus of claim 47, further comprising:
means for storing information obtained from the attempt of the first receive chain; and
means for utilizing the stored information during an second attempt to acquire the first channel using the second receive chain.

49. The apparatus of claim 48, wherein the means for utilizing of the stored information comprises:
means for combining the stored information with information obtained during the second attempt to acquire the first channel using the second receive chain; and
means for utilizing the combined information in the second attempt to acquire the first channel.

50. The apparatus of claim 47, further comprising:
means for attempting to acquire a second channel using the first receive chain based on a failure of acquisition of the first channel; and
means for selectively enabling the second receive chain to attempt to acquire the second channel based on a result of the acquisition of the second channel.

51. An apparatus for wireless communication comprising:
means for determining a list of channels to be acquired by a wireless device comprising Mobile Receive Diversity (MRD) capability, the list of channels comprising a subset of channels previously acquired by the wireless device; and
means for attempting acquisition of a channel by initially disabling the MRD capability of the wireless device if the channel is in the subset of channels.

52. The apparatus of claim 51, wherein the means for attempting of the acquisition comprises:
means for using only a first receive chain to acquire the channel as a first attempt to acquire the channel; and
means for performing a second attempt at the acquisition of the channel using a second receive chain based on the first attempt to acquire the channel.

53. The apparatus of claim 51, wherein the subset of channels comprises a Most Recently Used (MRU) list of channels.

54. The apparatus of claim 51, wherein the list of channels comprises a Preferred Roaming List (PRL).

55. A computer program product for wireless communications, comprising:
a machine-readable storage medium comprising code for:
enabling at least two receive chains in a wireless device to capture a first channel parameter for a channel from each of the at least two receive chains;
determining at least one threshold related to the first channel parameter; and
performing acquisition of the channel using Mobile Receive Diversity (MRD) based on the captured first channel parameter from each of the at least two receive chains and the at least one threshold.

56. The computer program product of claim 55, wherein the code for performing the acquisition using MRD comprises code for:
attempting an acquisition of the channel using one of the at least two receive chains; and
attempting, based on a result of the acquisition of the channel using the one of the at least two receive chains, another acquisition using another one or more of the at least two receive chains.

57. The computer program product of claim 56, wherein the code for attempting of the other acquisition comprises code for:
performing a search for the channel utilizing the other one of the at least two receive chains; and
combining the results of the acquisition attempt of the first channel using the one of the at least two receive chains with the search for the channel utilizing the other one of the at least two receive chains.

58. The computer program product of claim 55, wherein the first channel parameter comprises an Automatic Gain Control (AGC).

59. The computer program product of claim 55, wherein the at least one threshold comprises a range comprising a high threshold and a low threshold.

60. The computer program product of claim 59, wherein the at least two receive chains comprises a first receive chain and a second receive chain, and wherein the performing of the acquisition of the channel using MRD comprises:
determining if the captured first channel parameter for the first receive chain is within the range of the at least one threshold; and
enabling the first receive chain based on the determination.

61. The computer program product of claim 60, wherein the code for performing of the acquisition of the wireless communication system using MRD further comprises:
code for determining if the captured first channel parameter for the second receive chain is within the range of the at least one threshold; and
code for enabling the second receive chain based on the determination.

62. The computer program product of claim 60, wherein the first receive chain is a primary receive chain and the second receive chain is a secondary receive chain.

63. The computer program product of claim 60, wherein only one of the first receive chain and the second receive chain is used in the acquisition.

64. The computer program product of claim 55, wherein the code for performing the acquisition using MRD comprises code for:
skipping an attempt for acquisition of the channel based on a determination that the captured first channel parameter from each of the at least two receive chains is not above the at least one threshold.

65. A computer program product for wireless communications, comprising:
a machine-readable storage medium comprising code for:
enabling a first receive chain in an attempt to acquire a first channel; and
selectively enabling a second receive chain based on a result of the attempt.

66. The computer program product of claim 65, further comprising:
storing information obtained from the attempt of the first receive chain; and
utilizing the stored information during an second attempt to acquire the first channel using the second receive chain.

67. The computer program product of claim 66, wherein the code for utilizing of the stored information comprises:
code for combining the stored information with information obtained during the second attempt to acquire the first channel using the second receive chain; and
code for utilizing the combined information in the second attempt to acquire the first channel.

68. The computer program product of claim 65, wherein the machine-readable storage medium further comprising code for:
attempting to acquire a second channel using the first receive chain based on a failure of acquisition of the first channel; and
selectively enabling the second receive chain to attempt to acquire the second channel based on a result of the acquisition of the second channel.

69. A computer program product for wireless communication comprising:
a machine-readable storage medium comprising code for:
determining a list of channels to be acquired by a wireless device comprising Mobile Receive Diversity (MRD) capability, the list of channels comprising a subset of channels previously acquired by the wireless device; and
attempting acquisition of a channel by initially disabling the MRD capability of the wireless device if the channel is in the subset of channels.

70. The computer program product of claim 69, wherein the code for attempting of the acquisition comprises code for:
using only a first receive chain to acquire the channel as a first attempt to acquire the channel; and
performing a second attempt at the acquisition of the channel using a second receive chain based on the first attempt to acquire the channel.

71. The computer program product of claim 69, wherein the subset of channels comprises a Most Recently Used (MRU) list of channels.

72. The computer program product of claim 69, wherein the list of channels comprises a Preferred Roaming List (PRL).
